(19) United States
(12) Patent Application Publication
(10) Pub. No.: US 2012/0001119 A1
(43) Pub. Date: Jan. 5, 2012

(54) High Energy Density Cathode Materials for Lithium Ion Batteries

(76) Inventor: Ying Shirley Meng, San Diego, CA (US)

(21) Appl. No.: 13/143,606

(22) PCT Filed: Mar. 24, 2010
(86) PCT No.: PCT/US10/28483

§ 371 Date: Jul. 7, 2011

Related U.S. Application Data
(60) Provisional application No. 61/162,766, filed on Mar. 24, 2009.

(51) Int. Cl. H01M 4/525; H01M 4/04

(52) U.S. Cl. 252/182.1

(57) ABSTRACT

Compounds and materials for improved cathodes are provided. A compound of the present invention can be of the general form Li₂MₓNi_{0.5-x-y}Mn_{1.5+y}O₄, where M is a transition metal. The compounds and materials of the present invention can be used as a cathode for a battery, such as a lithium ion battery. The compounds and materials of the present invention provide high energy and power density at low cost.

### CROSS-REFERENCE TO A RELATED APPLICATION

This application claims the benefit of U.S. provisional application Ser. No. 61/162,766, filed Mar. 24, 2009, which is incorporated herein by reference in its entirety.

### BACKGROUND OF THE INVENTION

As the use of cordless and portable devices, such as laptop computers, becomes more and more common, the need keeps increasing for compact, lightweight batteries with high energy density to use as power sources for those devices. In particular, lithium batteries are commonly cited as examples of batteries that could be dominant for portable devices.

In lithium-ion batteries, the cathode is typically the most expensive active component. Additionally, the cathode generally comprises the highest mass fraction of the battery and can play a critical role in determining the energy density of the battery by setting the positive electrode potential. Moreover, the cathode often limits the charge/discharge rate of the battery system.

There are currently three major classes of cathodes that are typically used in lithium-based batteries. Olivines, such as LiFePO₄, have been used, as have stabilized LiMn₂O₄ spinels. In addition, stabilized Li(Ni, Co, or Al)O₂ layered oxides have been investigated. One example of a stabilized layered oxide currently available uses LiCoO₂, with a maximum voltage of 4 V, as the positive electrode active material. However, LiCoO₂ can be costly because cobalt is an expensive material. Nickel and aluminum are sometimes used as a substitute for costly cobalt.

The crystal structure of LiNiO₂ can change during charging/discharging cycles, which can lead to deterioration of the cathode. Thus, the use of this material for a cathode can have significant drawbacks.

The use of olivines, stabilized LiMn₂O₄ spinels, and stabilized Li(Ni, Co, or Al)O₂ layered oxides as a cathode in a lithium-ion battery have each been investigated thoroughly. Each of these compounds has been relatively optimized, and only incremental improvements are anticipated.

Thus, there exists a need in the art for an improved material for a cathode in a lithium-ion battery, capable of high energy density.

### BRIEF SUMMARY OF THE INVENTION

The present invention provides novel and advantageous materials for use as a cathode in a lithium-ion battery. The materials of the subject invention can provide improved energy density and charge/discharge properties over existing materials.

In one embodiment of the present invention, a compound can be of the general form Li₂MₓNi_{0.5-x-y}Mn_{1.5+y}O₄, wherein M is a transition metal.

In another embodiment, a lithium-ion battery can include a cathode, and the cathode can comprise a compound of the general form Li₂MₓNi_{0.5-x-y}Mn_{1.5+y}O₄, wherein M is a transition metal.

In yet another embodiment, a material for a cathode of a battery can include a compound of the general form Li₂MₓNi_{0.5-x-y}Mn_{1.5+y}O₄, wherein M is a transition metal.

In yet another embodiment, a method for producing a compound of the general form Li₂MₓNi_{0.5-x-y}Mn_{1.5+y}O₄ is provided, wherein M is a transition metal.

Advantageously, the compounds, materials, batteries, and methods of the present invention can provide increased energy density to meet the increasing demands for power for portable devices.

### BRIEF DESCRIPTION OF THE DRAWINGS

FIG. 1 shows energy density of cathode materials for a lithium ion battery. The cathode material of the present invention is highlighted on the far right in a box.

FIG. 2 shows charge-discharge curves for materials of the present invention. There is very little, if any, capacity fading for up to five cycles.

FIG. 3 shows a TEM image of a compound according to the present invention.

FIG. 4 shows charge-discharge curves for materials of the present invention.

FIG. 5 shows capacity vs. voltage curves for materials of the present invention.

FIG. 6 shows calculations demonstrating that distortion can be minimized in materials of the present invention.

### DETAILED DESCRIPTION OF THE INVENTION

The present invention provides novel and advantageous compounds and materials for use as a cathode in a lithium-ion battery. The materials of the subject invention can provide improved energy density and charge/discharge properties over existing materials.

In one embodiment of the present invention, a compound can be of the general form Li₂MₓNi_{0.5-x-y}Mn_{1.5+y}O₄, wherein M is a transition metal. The transition metal can be any transition metal, including, but not limited to, titanium, manganese, iron, cobalt, nickel, zinc, zirconium, molybdenum, silver, cadmium, hafnium, tantalum, tungsten, platinum, gold, palladium, chromium, or copper.

In a particular embodiment, the transition metal, M, can be chromium, copper, or cobalt.

In the compound of the general form, Li₂MₓNi_{0.5-x-y}Mn_{1.5+y}O₄ (where M is a transition metal), x can have a value in the range of 0.02 to 0.08, inclusive; and y can have a value in the range of 0.05 to 0.25, inclusive. However, the values of x and y can depend on which transition metal, M, is present.

For example, x can have a value in any of the following ranges, each of which is inclusive of the endpoints: 0.02 to 0.03; 0.02 to 0.04; 0.02 to 0.05; 0.02 to 0.06; 0.02 to 0.07; 0.02 to 0.08; 0.03 to 0.04; 0.03 to 0.05; 0.03 to 0.06; 0.03 to 0.07; 0.03 to 0.08; 0.04 to 0.05; 0.04 to 0.06; 0.04 to 0.07; 0.04 to 0.08; 0.05 to 0.06; 0.05 to 0.07; 0.05 to 0.08; 0.06 to 0.07; 0.06 to 0.08; or 0.07 to 0.08.

Also, y can have a value in any of the following ranges, each of which is inclusive of the endpoints: 0.05 to 0.06; 0.05 to 0.07; 0.05 to 0.08; 0.05 to 0.09; 0.05 to 0.10; 0.05 to 0.11; 0.05 to 0.12; 0.05 to 0.13; 0.05 to 0.14; 0.05 to 0.15; 0.05 to 0.16; 0.05 to 0.17; 0.05 to 0.18; 0.05 to 0.19; 0.05 to 0.20; 0.05 to 0.21; 0.05 to 0.22; 0.05 to 0.23; 0.05 to 0.24; 0.05 to 0.25; 0.06 to 0.07; 0.06 to 0.08; 0.06 to 0.09; 0.06 to 0.10; 0.06 to 0.11; 0.06 to 0.12; 0.06 to 0.13; 0.06 to 0.14; 0.06 to 0.15; 0.06 to 0.16; 0.06 to 0.17; 0.06 to 0.18; 0.06 to 0.19; 0.06 to 0.20; 0.06 to 0.21; 0.06 to 0.22; 0.06 to 0.23; 0.06 to 0.24; 0.06 to 0.25; 0.07 to 0.08; 0.07 to 0.09; 0.07 to 0.10; 0.07 to 0.11; 0.07 to 0.12; 0.07 to 0.13; 0.07 to 0.14; 0.07 to 0.15; 0.07 to 0.16; 0.07 to 0.17; 0.07 to 0.18; 0.07 to 0.19; 0.07 to 0.20; 0.07 to 0.21; 0.07 to 0.22; 0.07 to 0.23; 0.07 to 0.24; 0.07 to 0.25; 0.08 to 0.09; 0.08 to 0.10; 0.08 to 0.11; 0.08 to 0.12; 0.08 to 0.13; 0.08 to 0.14; 0.08 to 0.15; 0.08 to 0.16; 0.08 to 0.17; 0.08 to 0.18; 0.08 to 0.19; 0.08 to 0.20; 0.08 to 0.21; 0.08 to 0.22; 0.08 to 0.23; 0.08 to 0.24; 0.08 to 0.25; 0.09 to 0.10; 0.09 to 0.11; 0.09 to 0.12; 0.09 to 0.13; 0.09 to 0.14; 0.09 to 0.15; 0.09 to 0.16; 0.09 to 0.17; 0.09 to 0.18; 0.09 to 0.19; 0.09 to 0.20; 0.09 to 0.21; 0.09 to 0.22; 0.09 to 0.23; 0.09 to 0.24; 0.09 to 0.25; 0.10 to 0.11; 0.10 to 0.12; 0.10 to 0.13; 0.10 to 0.14; 0.10 to 0.15; 0.10 to 0.16; 0.10 to 0.17; 0.10 to 0.18; 0.10 to 0.19; 0.10 to 0.20; 0.10 to 0.21; 0.10 to 0.22; 0.10 to 0.23; 0.10 to 0.24; 0.10 to 0.25; 0.11 to 0.12; 0.11 to 0.13; 0.11 to 0.14; 0.11 to 0.15; 0.11 to 0.16; 0.11 to 0.17; 0.11 to 0.18; 0.11 to 0.19; 0.11 to 0.20; 0.11 to 0.21; 0.11 to 0.22; 0.11 to 0.23; 0.11 to 0.24; 0.11 to 0.25; 0.12 to 0.13; 0.12 to 0.14; 0.12 to 0.15; 0.12 to 0.16; 0.12 to 0.17; 0.12 to 0.18; 0.12 to 0.19; 0.12 to 0.20; 0.12 to 0.21; 0.12 to 0.22; 0.12 to 0.23; 0.12 to 0.24; 0.12 to 0.25; 0.13 to 0.14; 0.13 to 0.15; 0.13 to 0.16; 0.13 to 0.17; 0.13 to 0.18; 0.13 to 0.19; 0.13 to 0.20; 0.13 to 0.21; 0.13 to 0.22; 0.13 to 0.23; 0.13 to 0.24; 0.13 to 0.25; 0.14 to 0.15; 0.14 to 0.16; 0.14 to 0.17; 0.14 to 0.18; 0.14 to 0.19; 0.14 to 0.20; 0.14 to 0.21; 0.14 to 0.22; 0.14 to 0.23; 0.14 to 0.24; 0.14 to 0.25; 0.15 to 0.16; 0.15 to 0.17; 0.15 to 0.18; 0.15 to 0.19; 0.15 to 0.20; 0.15 to 0.21; 0.15 to 0.22; 0.15 to 0.23; 0.15 to 0.24; 0.15 to 0.25; 0.16 to 0.17; 0.16 to 0.18; 0.16 to 0.19; 0.16 to 0.20; 0.16 to 0.21; 0.16 to 0.22; 0.16 to 0.23; 0.16 to 0.24; 0.16 to 0.25; 0.17 to 0.18; 0.17 to 0.19; 0.17 to 0.20; 0.17 to 0.21; 0.17 to 0.22; 0.17 to 0.23; 0.17 to 0.24; 0.17 to 0.25; 0.18 to 0.19; 0.18 to 0.20; 0.18 to 0.21; 0.18 to 0.22; 0.18 to 0.23; 0.18 to 0.24; 0.18 to 0.25; 0.19 to 0.20; 0.19 to 0.21; 0.19 to 0.22; 0.19 to 0.23; 0.19 to 0.24; 0.19 to 0.25; 0.20 to 0.21; 0.20 to 0.22; 0.20 to 0.23; 0.20 to 0.24; 0.20 to 0.25; 0.21 to 0.22; 0.21 to 0.23; 0.21 to 0.24; 0.21 to 0.25; 0.22 to 0.23; 0.22 to 0.24; 0.22 to 0.25; 0.23 to 0.24; 0.23 to 0.25; or 0.24 to 0.25.

The compound of the general form Li₂MₓNi_{0.5-x-y}Mn_{1.5+y}O₄, wherein M is a transition metal, can be used as a material for a cathode for a battery. The battery can be, for example, a lithium-ion battery. Thus, in another embodiment of the present invention, a lithium-ion battery can include a cathode, and the cathode can comprise a compound of the general form Li₂MₓNi_{0.5-x-y}Mn_{1.5+y}O₄, wherein M is a transition metal. In a particular embodiment, x can have a value in the range of 0.02 to 0.08, inclusive; and y can have a value in the range of 0.05 to 0.25, inclusive. Though, as previously discussed, the values of x and y can be dependent on the transition metal, M. Thus, x and y can have values in any of the ranges listed above.

In specific embodiments, the transition metal can be chromium, copper, or cobalt.

The compounds and materials of the present invention can provide increased energy density over existing materials used as cathodes for batteries. Additionally, the compounds and materials of the present invention can provide good energy density at low cost.

Because the manganese oxidation state is mainly Mn⁴⁺, the compounds and materials of the present invention can be very stable such that effectively no manganese dissolution occurs. In addition, the use of a nickel reduction-oxidation (redox) couple can increase the lithium intercalation potential of the material to about 4.7 V.

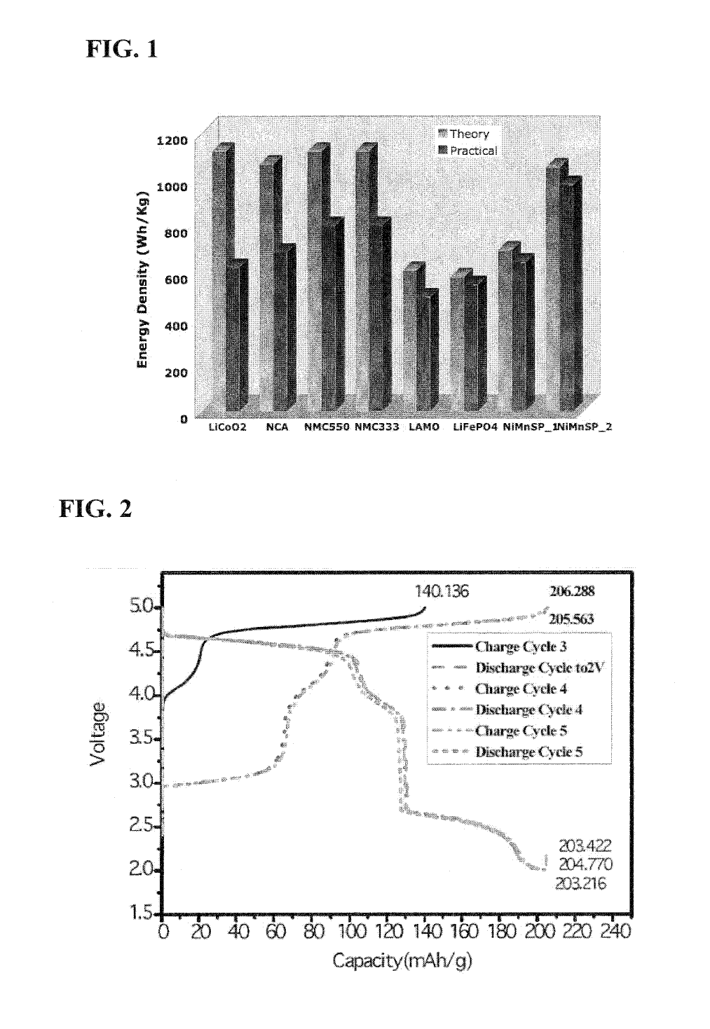

Referring to FIG. 1, theoretical energy density of the spinel material of the present invention is very high, and the practical energy density is much higher than that of any existing cathode material. Surprisingly and advantageously, the practical energy density of the compound of the general form Li₂MₓNi_{0.5-x-y}Mn_{1.5+y}O₄, where M is a transition metal, is about 1000 W-hr/kg (Watt-hours per kilogram), or about 1 kW-hr/kg. Thus, in a further embodiment of the present invention, a compound or material of the general form Li₂MₓNi_{0.5-x-y}Mn_{1.5+y}O₄, where M is a transition metal, can have an energy density of at least 1 kW-hr/kg. Accordingly, batteries comprising a cathode of the present invention can be used for many practical applications. A battery of the present invention could be used as, for example, a battery to power a hybrid electric car.

Batteries of the subject invention can also be used for many other common applications, including but not limited to cellular phones, laptop computers, and portable digital music players.

Additionally, compounds and materials of the present invention surprisingly exhibit improved charge/discharge cycle properties. Referring to FIG. 2, the voltage (in volts, V) is shown as a function of the capacity (in milliamp-hours per gram, mAh/g) of a material of the present invention. As seen in FIG. 2, there is advantageously very little, if any, capacity fading for up to five cycles of charging and discharging. Accordingly, batteries utilizing the materials of the present invention can last for a long time, in addition to providing high energy and power density.

A compound of the general form Li₂MₓNi_{0.5-x-y}Mn_{1.5+y}O₄ (where M is a transition metal) can be prepared by, for example, sol-gel methods. In an embodiment, a mixture of Li(CH₃COO).2H₂O, Ni(CH₃COO)₂.4H₂O, and Mn(CH₃COO)₂.4H₂O can be prepared in distilled water, and a an M acetate (where M is a transition metal) can be added to the solution. The solution can then be added to an aqueous solution of an acid. The acid can be, for example, citric acid.

The pH of the mixed solution can optionally be adjusted by adding a basic solution. The basic solution can be, for example, an ammonium hydroxide solution. The mixed solution can then be heated to obtain a gel. The mixed solution can be heated at a temperature of from about 50° C. to about 300° C. for a period of time of from about 30 minutes to about 72 hours. In a particular embodiment, the mixed solution can be heated at a temperature of about 75° C. for a period of time of about from 8 hours to about 16 hours to obtain a transparent gel.

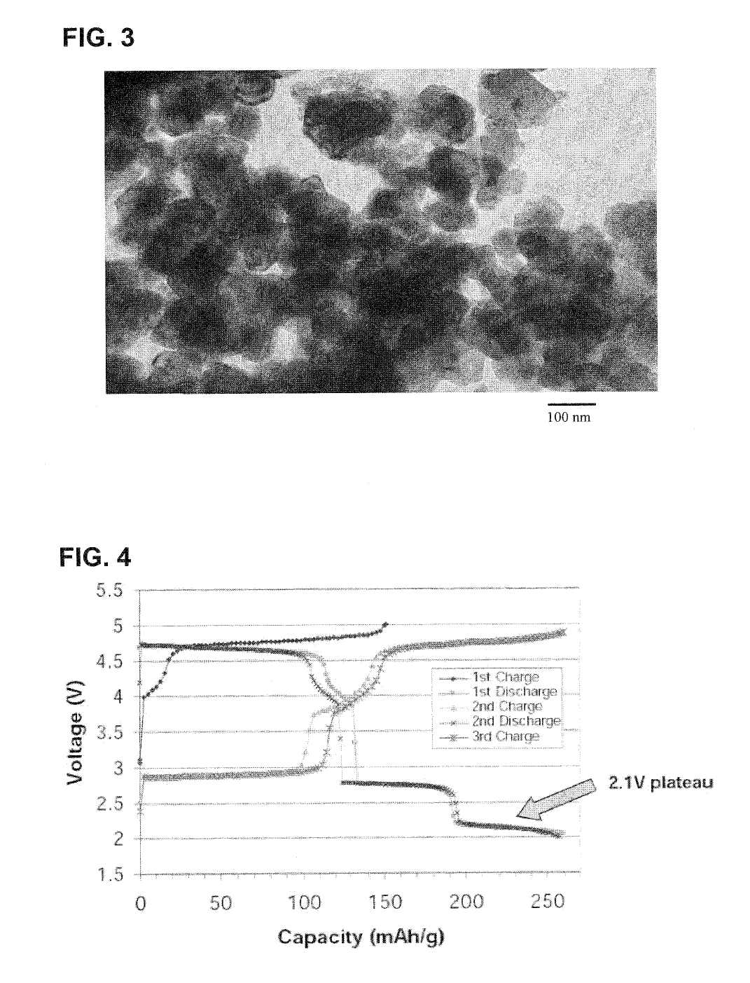

The gel can be decomposed at a temperature of from about 200° C. to about 600° C. for a period of time of from about 1 hour to about 72 hours, and then calcined at a temperature of about 500° C. to about 1000° C. for a period of time of about 1 hour to about 72 hours. In an embodiment, the gel can be decomposed in air. In a particular embodiment, the gel can be decomposed at a temperature of about 400° C. for about 10 hours in air and then calcined at a temperature of about 800° C. for about 10 hours to give the compound of the general form Li₂MₓNi_{0.5-x-y}Mn_{1.5+y}O₄ (where M is a transition metal). Referring to FIG. 3, a TEM image is shown of LiMₓNi_{0.5-x-y}Mn_{1.5+y}O₄ obtained via a sol-gel process. The particles exhibit a relatively uniform particle size around 100 nm and are highly crystalline.

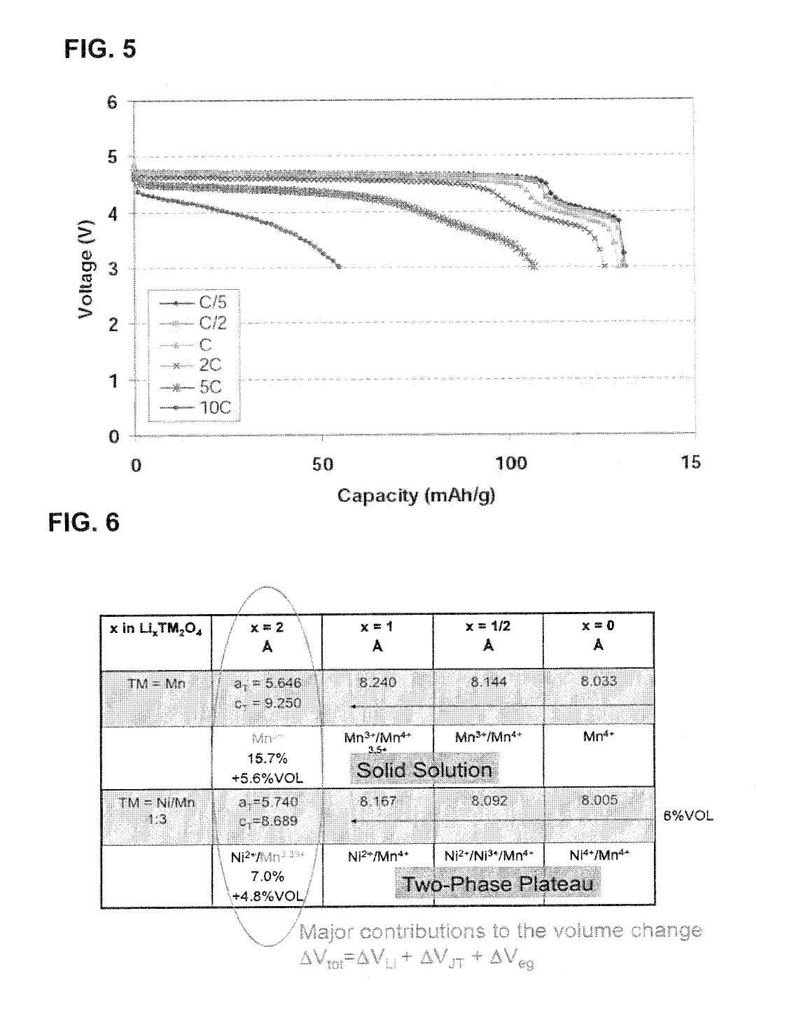

Referring to FIG. 4, charge/discharge curves are shown; Li₂(MₓNi_{0.5-x}Mn_{0.5+x+y}O₄ can be produced at discharge. Referring to FIG. 5, excellent rate capability is observed which can meet high power requirements, e.g. the power requirement of a plug-in hybrid vehicle (PHEV).

The compounds, materials, batteries, and methods of the present invention can provide show minimized distortion. Referring to FIG. 6, the Jahn-Teller distortion can be minimized according to the calculation shown. The volume change and the distortion induced by Jahn-Teller can be smaller than related Mn spinel materials.

Advantageously, the compounds, materials, batteries, and methods of the present invention can provide increased energy and power density over existing materials, at low cost, as well as displaying improved charge/discharge properties.

Table 1 shows first principles calculations for lithium diffusion activation barriers for lithium ion batteries at room temperature. The calculations are for simulated supercell LiM_{1/2}Mn_{3/2}O₄ (where M is a transition metal, such as Co, Cr, Cu, Fe, or Ni), which is comprised of an 8 formula unit. The calculations are based on the density functional theory (DFT) applied within the general gradient approximation (GGA) using PAW pseudopotentials. First principle methods rely on the basic laws of physics such as quantum mechanics and statistical mechanics, and therefore do not require any experimental input beyond the nature of the constituent elements (and in some cases the structure).

Referring to Table 1, copper and cobalt doping can provide a low lithium diffusion activation barrier at room temperature. That is, charge/discharge rates can be faster if copper or cobalt is used as the transition metal in the spinel framework of an electrode material of the present invention.

TABLE 1
First Principles Calculations for Activation
Barriers at Room Temperature

| | # of transition metal ions in | |
|---|---|---|
| Doped ion | the ring of the activated state | Barrier (eV) |
| Cobalt (Co) | 3 | 0.256 |
| Co | 1 | 0.356 |
| Chromium (Cr) | 3 | 0.374 |
| Cr | 1 | 0.344 |
| Copper (Cu) | 3 | 0.355 |
| Cu | 1 | 0.256 |
| Iron (Fe) | 3 | 0.333 |
| Fe | 1 | 0.339 |
| Nickel (Ni) | 3 | 0.326 |
| Ni | 1 | 0.312 |

### EXEMPLIFIED EMBODIMENTS

The invention includes, but is not limited to, the following embodiments:

### Embodiment 1

A compound of the general form Li₂MₓNi_{0.5-x-y}Mn_{1.5+y}O₄, wherein M is a transition metal.

### Embodiment 2

The compound according to embodiment 1, wherein M is chromium.

### Embodiment 3

The compound according to embodiment 1, wherein M is copper.

### Embodiment 4

The compound according to embodiment 1, wherein M is cobalt.

### Embodiment 5

The compound according to any of embodiments 1-4, wherein a lithium intercalation potential of the compound is about 4.7 V.

### Embodiment 6

The compound according to any of embodiments 1-5, wherein the energy density of the compound is about 1000 W-hr/kg.

### Embodiment 7

A material for a cathode of a battery, wherein the material comprises a compound of the general form Li₂MₓNi_{0.5-x-y}Mn_{1.5+y}O₄, wherein M is a transition metal.

### Embodiment 8

The material according to embodiment 7, wherein M is chromium.

### Embodiment 9

The material according to embodiment 7, wherein M is copper.

### Embodiment 10

The material according to embodiment 7, wherein M is cobalt.

### Embodiment 11

The material according to any of embodiments 7-10, wherein a lithium intercalation potential of the battery is about 4.7 V.

### Embodiment 12

The material according to any of embodiments 7-11, wherein the energy density of the material is about 1000 W-hr/kg.

### Embodiment 13

The material according to any of embodiments 7-12, wherein the battery is a lithium-ion battery.

### Embodiment 14

A lithium-ion battery comprising a cathode, wherein the cathode comprises a compound of the general form Li₂MₓNi_{0.5-x-y}Mn_{1.5+y}O₄, wherein M is a transition metal.

### Embodiment 15

The lithium-ion battery according to embodiment 14, wherein M is chromium.

### Embodiment 16

The lithium-ion battery according to embodiment 14, wherein M is copper.

### Embodiment 17

The lithium-ion battery according to embodiment 14, wherein M is cobalt.

### Embodiment 18

The lithium-ion battery according to any of embodiments 14-17, wherein a lithium intercalation potential of the compound is about 4.7 V.

### Embodiment 19

The lithium-ion battery according to any of embodiments 14-18, wherein the energy density of the compound is about 1000 W-hr/kg.

### Embodiment 20

A method of preparing a compound of the general form Li₂MₓNi_{0.5-x-y}Mn_{1.5+y}O₄, wherein M is a transition metal, the method comprising:

preparing a first solution by mixing Li(CH₃COO).2H₂O, Ni(CH₃COO)₂.4H₂O, and Mn(CH₃COO)₂.4H₂O in water;

adding an M acetate to the first solution, wherein M is the transition metal;

adding the first solution to an aqueous solution of an acid to form a mixed solution;

heating the mixed solution to obtain a gel;

decomposing the gel; and

calcining the gel.

### Embodiment 21

The method according to embodiment 20, wherein the acid is citric acid.

### Embodiment 22

The method according to any of embodiments 20-21, further comprising adding a basic solution to the mixed solution before heating the mixed solution.

### Embodiment 23

The method according to embodiment 22, wherein the basic solution is an ammonium hydroxide solution.

### Embodiment 24

The method according to any of embodiments 20-23, wherein the mixed solution is heated at a temperature of about 75° C. for a period of time of from about 8 hours to about 16 hours.

### Embodiment 25

The method according to any of embodiments 20-24, wherein the gel is decomposed in air.

### Embodiment 26

The method according to any of embodiments 20-25, wherein the gel is decomposed in air at a temperature of about 400° C. for a period of time of about 10 hours.

### Embodiment 27

The method according to any of embodiments 20-26, wherein the gel is calcined at a temperature of about 800° C. for a period of time of about 10 hours.

### Embodiment 28

The method according to any of embodiments 20-27, wherein a lithium intercalation potential of the compound is about 4.7 V.

### Embodiment 29

The method according to any of embodiments 20-28, wherein the energy density of the compound is about 1000 W-hr/kg.

### Embodiment 30

The method according to any of embodiments 20-29, wherein M is chromium.

### Embodiment 31

The method according to any of embodiments 20-29, wherein M is Copper.

### Embodiment 32

The method according to any of embodiments 20-29, wherein M is cobalt.

The following examples illustrate procedures for practicing the invention. These examples should not be construed as limiting. All percentages are by weight and all solvent mixture proportions are by volume unless otherwise noted. It will be apparent to those skilled in the art that the examples involve use of materials and reagents that are commercially available from known sources, e.g., chemical supply houses, so no details are given respecting them.

### Example 1

Sol solutions were prepared from stoichiometric mixtures of Li(CH₃COO).2H₂O, Ni(CH₃COO)).4H₂O, and Mn(CH₃COO)₂.4H₂O in distilled water. The solution was then added dropwise to a continuously stirred aqueous solution of citric acid. The pH of the mixed solution was adjusted by adding ammonium hydroxide solution. The solution was then heated at a temperature of about 75° C. overnight. A transparent gel was obtained. The resulting gel precursors were decomposed at a temperature of about 400° C. for about 10 hours in air and then calcined at a temperature of about 800° C. for about 10 hours.

### Example 2

Sol solutions were prepared from stoichiometric mixtures of Li(CH₃COO).2H₂O, Ni(CH₃COO)₂.4H₂O, and Mn(CH₃COO)₂.4H₂O in distilled water. Chromium acetate was added to the distilled water according to the stoichiometry. The solution was then added dropwise to a continuously stirred aqueous solution of citric acid. The pH of the mixed solution was adjusted by adding ammonium hydroxide solution. The solution was then heated at a temperature of about 75° C. overnight. A transparent gel was obtained. The resulting gel precursors were decomposed at a temperature of about 400° C. for about 10 hours in air and then calcined at a temperature of about 800° C. for about 10 hours to produce a compound of the form Li₂CrₓNi_{0.5-x-y}Mn_{1.5+y}O₄.

### Example 3

Sol solutions were prepared from stoichiometric mixtures of Li(CH₃COO).2H₂O, Ni(CH₃COO)₂.4H₂O, and Mn(CH₃COO)₂.4H₂O in distilled water. Copper acetate was added to the distilled water according to the stoichiometry. The solution was then added dropwise to a continuously stirred aqueous solution of citric acid. The pH of the mixed solution was adjusted by adding ammonium hydroxide solution. The solution was then heated at a temperature of about 75° C. overnight. A transparent gel was obtained. The resulting gel precursors were decomposed at a temperature of about 400° C. for about 10 hours in air and then calcined at a temperature of about 800° C. for about 10 hours to produce a compound of the form Li₂CuₓNi_{0.5-x-y}Mn_{1.5+y}O₄.

### Example 4

Sol solutions were prepared from stoichiometric mixtures of Li(CH₃COO).2H₂O, Ni(CH₃COO)₂.4H₂O, and Mn(CH₃COO)₂.4H₂O in distilled water. Cobalt acetate was added to the distilled water according to the stoichiometry. The solution was then added dropwise to a continuously stirred aqueous solution of citric acid. The pH of the mixed solution was adjusted by adding ammonium hydroxide solution. The solution was then heated at a temperature of about 75° C. overnight. A transparent gel was obtained. The resulting gel precursors were decomposed at a temperature of about 400° C. for about 10 hours in air and then calcined at a temperature of about 800° C. for about 10 hours to produce a compound of the form Li₂CoₓNi_{0.5-x-y}Mn_{1.5+y}O₄.

All patents, patent applications, provisional applications, and publications referred to or cited herein, supra or infra, are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

What is claimed is:

1. A compound of the general form Li₂MₓNi_{0.5-x-y}Mn_{1.5+y}O₄, wherein M is a transition metal, and wherein x is in a range of from 0.02 to 0.08, and wherein y is in a range of from 0.05 to 0.25.

2. The compound according to claim 1, wherein M is chromium.

3. The compound according to claim 1, wherein M is copper.

4. The compound according to claim 1, wherein M is cobalt

5. The compound according to claim 1, wherein a lithium intercalation potential of the compound is about 4.7 V.

6. The compound according to claim 1, wherein the energy density of the compound is about 1000 W-hr/kg.

7. A material for a cathode of a battery, wherein the material comprises a compound of the general form Li₂MₓNi_{0.5-x-y}Mn_{1.5+y}O₄, wherein M is a transition metal and wherein x is in a range of from 0.02 to 0.08, and wherein y is in a range of from 0.05 to 0.25.

8. The material according to claim 7, wherein the battery is a lithium-ion battery.

9. The material according to claim 7, wherein M is chromium.

10. The material according to claim 7, wherein M is copper.

11. The material according to claim 7, wherein M is cobalt.

12. The material according to claim 7, wherein a lithium intercalation potential of the battery is about 4.7 V.

13. The material according to claim 7, wherein the energy density of the material is about 1000 W-hr/kg.

14. A method of preparing a compound of the general form Li₂MₓNi_{0.5-x-y}Mn_{1.5+y}O₄, wherein M is a transition metal, the method comprising:
preparing a first solution by mixing Li(CH₃COO).2H₂O, Ni(CH₃COO)₂.4H₂O, and Mn(CH₃COO)₂.4H₂O in water;
adding an M acetate to the first solution, wherein M is the transition metal;
adding the first solution to an aqueous solution of an acid to form a mixed solution;
heating the mixed solution to obtain a gel;
decomposing the gel; and
calcining the gel.

15. The method according to claim 15, wherein the mixed solution is heated at a temperature of about 75° C. for a period of time of from about 8 hours to about 16 hours.

16. The method according to claim 14, wherein the gel is decomposed in air at a temperature of about 400° C. for a period of time of about 10 hours.

17. The method according to claim 14, wherein the gel is calcined at a temperature of about 800° C. for a period of time of about 10 hours.

18. The method according to claim 14, wherein M is chromium.

19. The method according to claim 14, wherein M is copper.

20. The method according to claim 14, wherein M is cobalt.
